(19) United States
(12) Patent Application Publication
(10) Pub. No.: US 2013/0110686 A1
(43) Pub. Date: May 2, 2013

(54) AUTOMATIC REPORT GENERATION SYSTEM AND METHOD THEREFOR

(71) Applicants: Michael Colin Berrington, Kurrajong (AU); Cameron Griffiths, Kurrajong (AU)

(72) Inventors: Michael Colin Berrington, Kurrajong (AU); Cameron Griffiths, Kurrajong (AU)

(21) Appl. No.: 13/695,038

(22) PCT Filed: Dec. 23, 2010
(86) PCT No.: PCT/AU2010/001732

§ 371 Date: Nov. 19, 2012

(30) Foreign Application Priority Data
Apr. 29, 2010 (AU) 2010201705

(51) Int. Cl. G06Q 40/00; G06F 17/21

(52) U.S. Cl. CPC G06Q 40/10; G06F 17/21
USPC 705/30; 715/273

(57) ABSTRACT

A tool for generation of reports; said tool accepting at least a first input comprising a set of n data elements from at least a first data repository; said tool associating individual ones of said elements with individual members from a graded code element set; said tool including a report structure device having said data elements and said code elements arranged in an array together with descriptor elements.

The present invention relates to an automatic report generation system and, more particularly, although not exclusively, to such a system adapted for the production of financial reports in industry standard formats.

### BACKGROUND

There are many industries where reports in a industry standard format are relied upon for informational, compliance or legal reasons. One example concerns financial reporting, where, for example, publicly listed companies are required to produce financial reports in standard forms to satisfy various audiences. For example, a report may be produced for stakeholders every year. Reports may also be produced for the purposes of auditing or taxation.

In the financial sphere, generation of such reports has involved a significant amount of manual input throughout the process of generating the report. That is, from the beginning where raw accounting data is collected through to printing the final document incorporating the collated financial and non-financial data into one coherent report. Even with the aid of computers, it has been observed that such reports take many hundreds of man-hours to generate, and the end result is not always as standardised or internally consistent and error free as the target audience may wish or require.

It is an object of the present invention to address or at least ameliorate some of the above disadvantages.

### Notes

1. The term “comprising” (and grammatical variations thereof) is used in this specification in the inclusive sense of “having” or “including”, and not in the exclusive sense of “consisting only of”.
2. The above discussion of the prior art in the Background of the invention, is not an admission that any information discussed therein is citable prior art or part of the common general knowledge of persons skilled in the art in any country.

### BRIEF DESCRIPTION OF INVENTION

Accordingly in one broad form of the invention there is provided a method for automatic generation of reports operating on a digital computer, said digital computer comprising at least a data processor in communication with a memory; said data processor adapted to execute instructions residing in said memory, the method comprising:
a. Gathering or reading input by said computer as to what report is to be generated;
b. Where a financial report is being produced, reading the contents of at least one trial balance by said computer;
c. Reading the contents of at least one client disclosure document by said computer;
d. Accepting manual input of content for inclusion in a report
e. Said computer applying rules and dependencies to data read from said at least one trial balance (where a financial report is being produced) and said at least one client disclosure document in order to determine what content is to be included in a report;
f. Said computer performing checks on the data read from said at least one trial balance (where a financial report is being produced) and said at least one client disclosure document to ensure consistency and compliance with predefined criteria;
g. Said computer generating said report in an electronic format using information from said at least one trial balance (where a financial report is being produced) and said at least one client disclosure document and said manual input;

Preferably the data entered into said at least one client disclosure document is validated by said computer to ensure consistency and integrity according to predefined criteria.

Preferably data entered into said at least one trial balance (where a financial report is being produced) is validated by said computer to ensure consistency and integrity according to predefined criteria.

Preferably the method is implemented as a computer program executable by said data processor; said program including:
a. A collection of content for inclusion in reports (FRS content);
b. A collection of rules and dependencies (FRS rules) to apply to said at least one trial balance (where a financial report is being produced) and said at least one client disclosure document to determine which elements of said FRS content is to be included in a report.

Preferably a unique code or alias (FRS codes) is used to identify individual elements in said at least one trial balance (where a financial report is being produced) and in said at least one client disclosure document and in said FRS content.

Preferably said FRS rules are expressed with reference to FRS codes.

Preferably the FRS rules are applied to said at least one trial balance (where a financial report is being produced) and said at least one client disclosure document to determine which elements of said FRS content are to be included in a report as the data is read or input into the system, rather than sequentially.

Preferably the report produced is checked by said computer to ensure consistency and integrity of data according to predefined criteria.

Preferably a report of inconsistencies within the data is produced by said computer.

Preferably the report is produced in an electronic format, including PDF, XBRL (eXtensible Business Reporting Language), or a format compatible with Microsoft Word, Microsoft Excel, or Adobe InDesign.

Preferably said computer also produces additional reports and supporting schedules, including Calculation Reports, Analytical Reports, Adjustment Reports, Audit Trails (refer to FIGS. 7 and 8), XBRL Exports, Statutory Profit Reconciliations and Internal Review Reports.

Preferably format and content in a predetermined master format is selected via a reporting options data entry device.

Preferably said data entry device is a data input screen deriving input from a keyboard linked via said data processor.

Accordingly in a further broad form of the invention there is provided a tool for generation of reports; said tool accepting at least a first input comprising a set of n data elements from at least a first data repository; said tool associating individual ones of said elements with individual members from a graded code element set; said tool including a report structure device having said data elements and said code elements arranged in an array together with descriptor elements.

Preferably said tool interposes data elements into a master data document.

Preferably every data element interposed in said master data document has associated with it an individual member from said graded code element set.

Preferably each graded code element comprises at least 5 consecutive data fields, wherein there is a hierarchy among the data fields according to relative position of the data fields with respect to each other.

Preferably the leftmost field takes the greatest precedence.

Preferably said leftmost field is associated with a particular data grouping of said data elements and the next field is associated with a sub-grouping of that same grouping of data elements.

### BRIEF DESCRIPTION OF DRAWINGS

Embodiments of the present invention will now be described with reference to the accompanying drawings wherein:

FIG. 1 is a block diagram of dataflow through a report generation engine in accordance with a first preferred embodiment of the present invention.

FIG. 2 is a block diagram of dataflow through an example of a report generation engine in accordance with a first preferred embodiment of the present invention that generates financial reports.

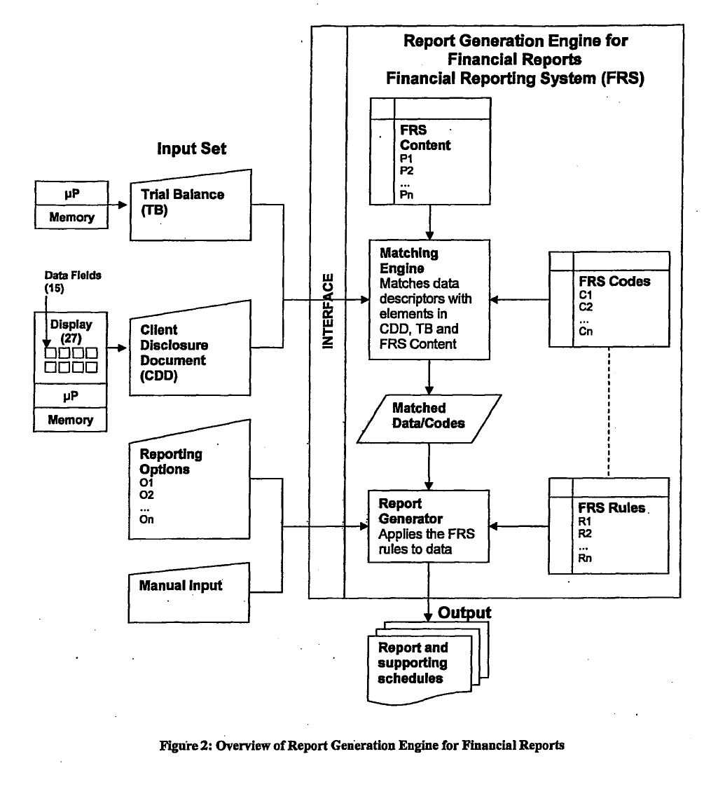

FIG. 3 is a screen shot of an example ‘reporting options’ screen, displaying the information required by the report generation engine to produce a report.

FIG. 4 is a table displaying the relationship between FRS Content and FRS Rules.

FIG. 5 is a sample of Codes used by a report generation engine in accordance with the first preferred embodiment of the present invention that generates financial reports.

FIG. 6 is an example client disclosure document that may be input into a report generation engine in accordance with the first preferred embodiment of the present invention that generates financial reports.

FIG. 7 is an example audit trail (FRS method) that may be exported from a report generation engine in accordance with the first preferred embodiment of the present invention that generates financial reports.

FIG. 8 is an example audit trail (traditional method) that may be exported from a report generation engine in accordance with the first preferred embodiment of the present invention that generates financial reports.

### DETAILED DESCRIPTION OF PREFERRED EMBODIMENTS

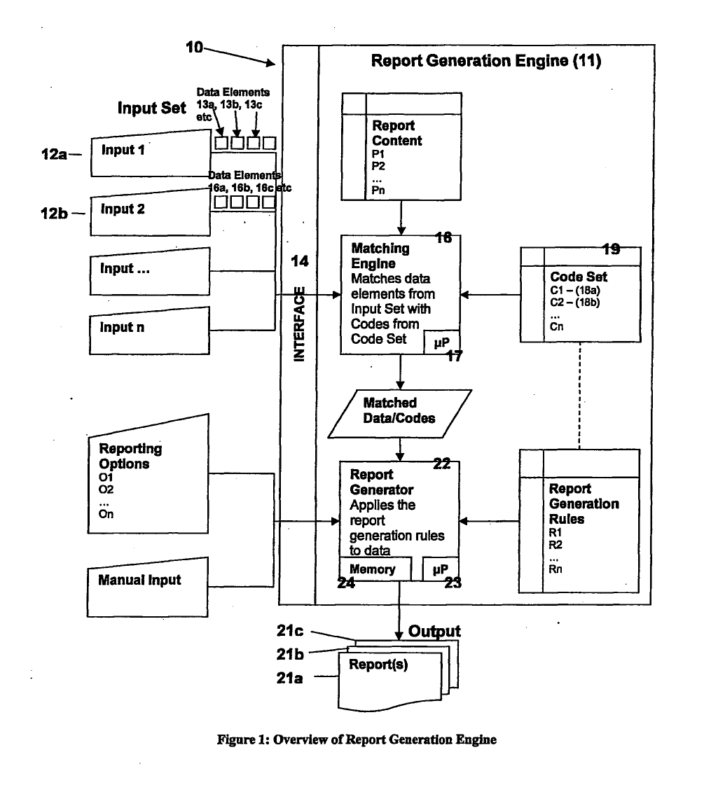

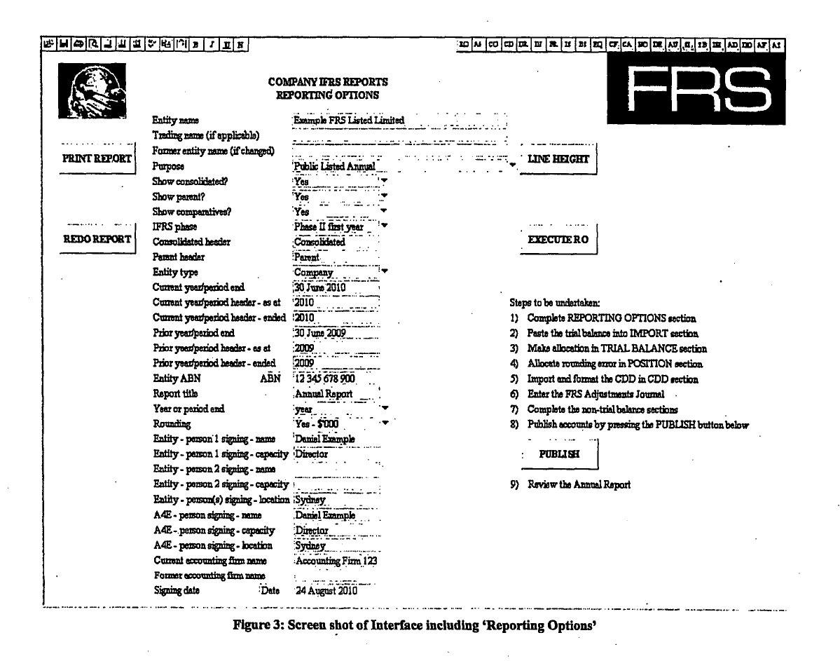

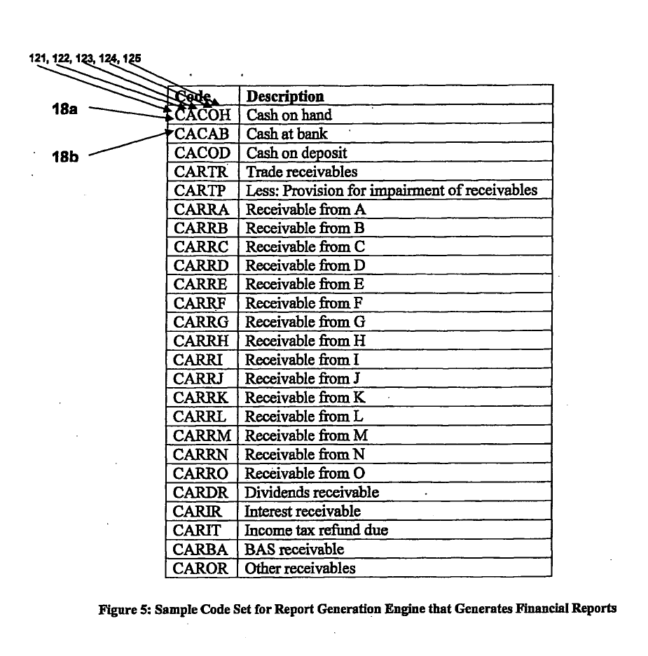

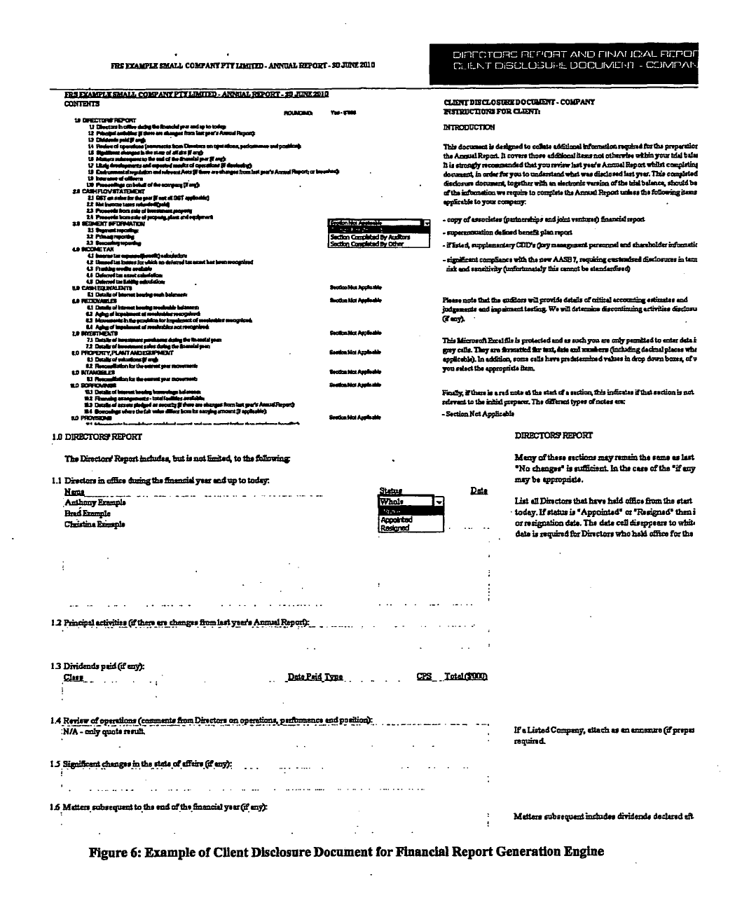

FIG. 1 illustrates a report generation engine in accordance with the first preferred embodiment of the present invention. In this instance the report generation engine comprises:
i) An interface for allowing input of ‘reporting options’ specifying, inter alia:
   a) what type of report is to be produced;
   b) the format for the report; and
   c) details of entities for whom the report has been produced.
A screenshot of an example of this interface is provided in FIG. 3.
ii) a data bank of content for inclusion in final reports (Report Content). Individual pieces of Report Content may include, for example, a specific sentence/phrase, a paragraph, a line of text or monetary figures, or part of or a complete table of financial or other information.
iii) a collection of codes/aliases to apply to specific pieces of data input into the system (Input Codes). For example, a code ‘CACOH’ may represent items pertaining to ‘Cash on hand’, while CACAB may pertain to ‘Cash at bank’. A list of example codes is provided in FIG. 5.
iv) a ‘matching engine’ that accepts data input into the system and matches individual pieces of data with Input Codes. The data input into the system may be provided in the form of:
   a) spreadsheets, for example, trial balance data; and/or
   b) a form containing further information relevant to the report being produced (Client Disclosure Document). For example, a Client Disclosure Document for a financial reporting system is provided in FIG. 6.
v) a collection of rules, phrased with reference to Input codes, for determining which pieces of Report Content are to be included in the final report (Report Rules); and
vi) a report generator, which applies the Report rules to the data input into the system to determine which individual pieces of Report Content are to be included in the final report.

The report generation system follows a series of steps. For example, a report generation engine that produces financial reports performs the following steps:
Step 1: Reporting Options—Accepting information about what report is to be produced, including:
   a) rounding information;
   b) the name of the company;
   c) the details of persons signing the report.
Step 2: Importing Trial Balance information from any General Ledger System.
Step 3: Importing one or more Client Disclosure Documents.
Step 4: Reading or retrieving FRS Content from the FRS Content data bank.
Step 5: Matching individual pieces of information contained in the trial balance and client disclosure document with FRS Codes. This is performed by the ‘matching engine’ component of the system. The process for matching individual pieces of information with FRS codes is described in Australian Complete Patent Application No: 2009233605, the disclosure of which is incorporated herein by cross reference.
Step 6: Accepting input of adjustment journals.
Step 7: Performing financial calculations based on the trial balance information, client disclosure document, financial adjustments and allocations.
Step 8: Accepting manual input not contained in the trial balance information or client disclosure document. This may include messages or textual reports from individuals that are to be included in the final report.
Step 9: Applying FRS rules to the information contained in the trial balance information and client disclosure document to determine which pieces of FRS Content are to be included in the report. Individual pieces of content are turned ‘on’ or ‘off’ (displayed or hidden) depending on the reporting options and information input from the trial balance and client disclosure document.
Step 10: Performing checks of the financial information imported to ensure consistency of data throughout the report.
Step 11: Exporting the report in any of a number of electronic document formats, including PDF, Microsoft Word, Microsoft Excel or Adobe InDesign. The exported report may be accompanied by additional supporting schedules including:
   a) Calculations Report;
   b) Adjustment Report;
   c) Account Allocation Audit Trails;
   d) XBRL Export;
   e) Old School Ratio's Analytical Report;
   f) Trial Balance to Statutory Profit Reconciliation;
   g) Internal Review Report

The order in which the above steps are performed may vary from the order in which they are displayed above. The above steps may be executed simultaneously as data is input into the system.

The report generation system may be implemented using any number of existing application development platforms or programming environments. This includes environments such as Microsoft's .NET framework, DB2, Microsoft Excel or Microsoft Access, or programming languages such as C++, Java, or Visual Basic.

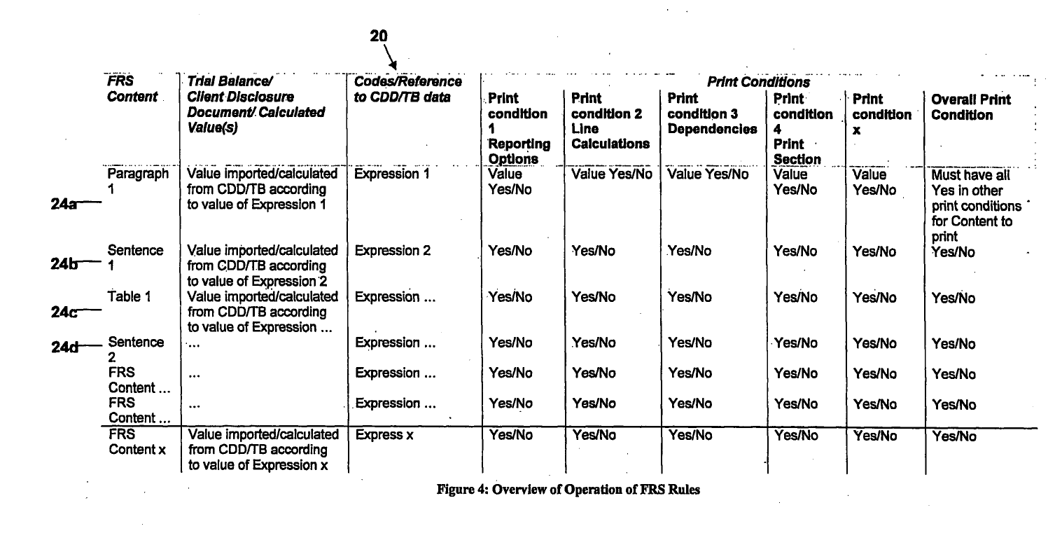

For example, in one form, the system may be implemented substantially in a Microsoft .NET environment conceptually as disclosed in part in FIG. 4, which can be further described as follows:
Column 1 contains all the FRS Content that can be included in a final report. This content may include values found in Column 2.
Column 2 contains the values calculated from the imported Trial Balance information and Client Disclosure Document which correspond to the FRS Codes and related calculations in column 3. These values are used in combination with the FRS Content in Column 1 in the final report.
Column 3 contains FRS Codes and calculations representing data in the Trial Balance Information and Client Disclosure Document that relate to the FRS Content in Column 1.
Column 4 contains 6 sub-columns containing a series of conditions that determine whether the FRS Content will be included in the final report. Sub-column 6 contains a condition that is true if sub-columns 1-5 are also true. If sub-column 6 is true, then the corresponding FRS Content in column 1 will be included in the final report.

In Use

In use, and with initial reference to FIG. 1, the automatic report generation system 10, shown there in diagrammatic and generalised form, can be thought of as a tool in the form of a report generation engine 11, which accepts input from at least a first input device 12a, and, more usually, from multiple input devices 12a, 12b . . . . In one form, the input device 12a can be an independent computer system, having relevant data stored therein. For example, in the case of the FRS system described earlier, the data stored on the computer system can be trial balance data which can be represented as a set, of n data elements 13a, 13b, 13c . . . via interface 14 to the report generation engine 11. In a further instance, the input device may take the form of a computer system having a data entry screen 17 (for example, in the form of a webpage entry screen) wherein a user enters relevant data in response to preformatted queries 15 displayed thereon, resulting in a corresponding input sequence of data elements 16a, 16b . . . being transmitted to report generation engine 11 via interface 14.

The data elements thus input are fed to matching engine 26. The matching engine 26 includes microprocessor 17 which is programmed to associate individual ones of the elements 13a, 13b . . . , 16a, 16b . . . with individual members 18a, 18b . . . of graded code element set 19 and thereby to place the associated data elements and code elements into a report structure device 20 (for example, of the type shown in FIG. 4). The graded code elements 18a, 18b . . . , in one form, comprise consecutive data fields (for example, as shown in FIG. 5) wherein there is a hierarchy amongst the data fields 121, 122, 123, 124, 125 according to the relative positions of the data fields with respect to each other. In the particular form shown in FIG. 5, the leftmost field 121 takes the greatest precedence, and so on from left to right. Particular ones of the data fields are associated with particular data groupings as will appear in one or more reports, with 21a, 21b . . . ultimately output from report generation engine 11.

The associated or matched data elements and graded code elements are passed to report generator 22, which itself can take the form of a computing device, including microprocessor 23, associated memory 24. The report generator 22 applies report generation rules R1, R2 . . . and, relying on other parameters and guidance as provided in the reporting options input (refer FIG. 3 for an example) and implemented as report structure device 20 (refer FIG. 4), a final report 21a, 21b, 21c . . . is produced.

The report structure device 20 includes a master data document populated with the data elements 13a . . . , 16a . . . , and from which selected portions are excised, if all print condition flags are not set to 1 for each master data document portion 24a, 24b, 24c . . . .

Thereby, a final report or reports are produced in the manner described above. The reports may relate to any field of endeavour. A detailed example has been given above wherein the data is financial data. The flag arrangement described with reference to FIG. 4 allows rapid calculation and production of the final reports as compared with other methodologies for processing similar forms of data.

The above describes only some embodiments of the present invention and modifications, obvious to those skilled in the art, can be made thereto without departing from the scope of the present invention.

1. A method for automatic generation of reports operating on a digital computer, said digital computer comprising at least a data processor in communication with a memory; said data processor adapted to execute instructions residing in said memory, the method comprising:
a. Gathering or reading input by said computer as to what report is to be generated;
b. Where a financial report is being produced, reading the contents of at least one trial balance by said computer;
c. Reading the contents of at least one client disclosure document by said computer;
d. Accepting manual input of content for inclusion in a report
e. Said computer applying rules and dependencies to data read from said at least one trial balance (where a financial report is being produced) and said at least one client disclosure document in order to determine what content is to be included in a report;
f. Said computer performing checks on the data read from said at least one trial balance (where a financial report is being produced) and said at least one client disclosure document to ensure consistency and compliance with predefined criteria;
g. Said computer generating said report in an electronic format using information from said at least one trial balance (where a financial report is being produced) and said at least one client disclosure document and said manual input;

2. The method of claim 1 wherein the data entered into said at least one client disclosure document is validated by said computer to ensure consistency and integrity according to predefined criteria.

3. The method of claim 1 wherein data entered into said at least one trial balance (where a financial report is being produced) is validated by said computer to ensure consistency and integrity according to predefined criteria.

4. The method of claim 1 wherein the method is implemented as a computer program executable by said data processor; said program including:
a. A collection of content for inclusion in reports (FRS content);
b. A collection of rules and dependencies (FRS rules) to apply to said at least one trial balance (where a financial report is being produced) and said at least one client disclosure document to determine which elements of said FRS content is to be included in a report.

5. The method of claim 1 wherein a unique code or alias (FRS codes) is used to identify individual elements in said at least one trial balance (where a financial report is being produced) and in said at least one client disclosure document and in said FRS content.

6. The method of claim 1 wherein said FRS rules are expressed with reference to FRS codes.

7. The method of claim 1 wherein the FRS rules are applied to said at least one trial balance (where a financial report is being produced) and said at least one client disclosure document to determine which elements of said FRS content are to be included in a report as the data is read or input into the system, rather than sequentially.

8. The method of claim 1 wherein the report produced is checked by said computer to ensure consistency and integrity of data according to predefined criteria.

9. The method of claim 8 wherein a report of inconsistencies within the data is produced by said computer.

10. The method of claim 1 wherein the report is produced in an electronic format, including PDF, XBRL (eXtensible Business Reporting Language), or a format compatible with Microsoft Word, Microsoft Excel, or Adobe InDesign.

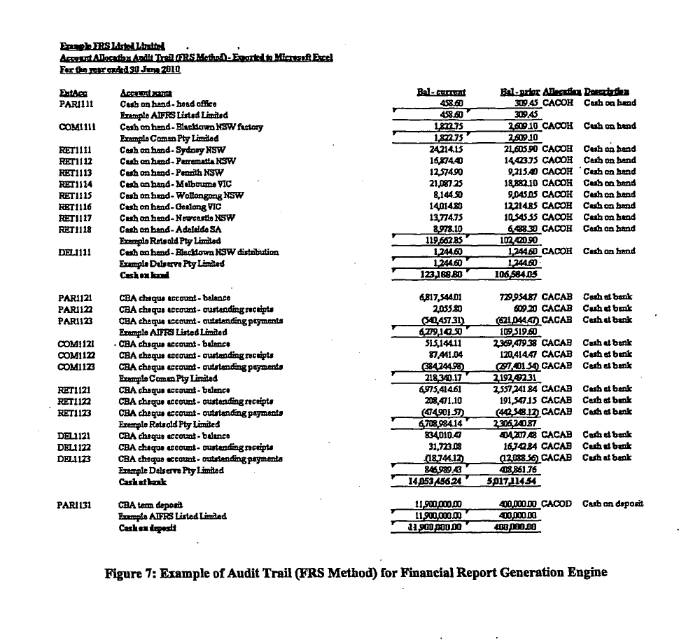

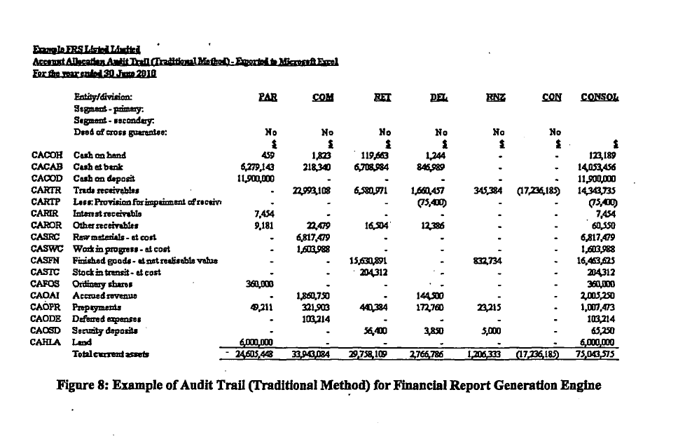

11. The method of claim 1 wherein said computer also produces additional reports and supporting schedules, including Calculation Reports, Analytical Reports, Adjustment Reports, Audit Trails (refer to FIGS. 7 and 8), XBRL Exports, Statutory Profit Reconciliations and Internal Review Reports.

12. The method of claim 1 wherein format and content in a predetermined master format is selected via a reporting options data entry device.

13. The method of claim 12 wherein said data entry device is a data input screen deriving input from a keyboard linked via said data processor.

14. The method of claim 1 wherein the calculation methodology is selected to increase speed of processing and publication of said report.

15. A tool for generation of reports; said tool accepting at least a first input comprising a set of n data elements from at least a first data repository; said tool associating individual ones of said elements with individual members from a graded code element set; said tool including a report structure device having said data elements and said code elements arranged in an array together with descriptor elements.

16. The tool of claim 15, wherein said tool interposes data elements into a master data document.

17. The tool of claim 16, wherein every data element interposed in said master data document has associated with it an individual member from said graded code element set.

18. The tool of claim 17, wherein each graded code element comprises at least 5 consecutive data fields, wherein there is a hierarchy among the data fields according to relative position of the data fields with respect to each other.

19. The tool of claim 18, wherein the leftmost field takes the greatest precedence.

20. The tool of claim 19, wherein said leftmost field is associated with a particular data grouping of said data elements and the next field is associated with a sub-grouping of that same grouping of data elements.

21. A machine readable medium including executable code executable on a processor which implements the method of claim 1.

22. A machine readable medium including executable code executable on a processor which implements the tool of claim 15.
